(19) United States
(12) Patent Application Publication
(10) Pub. No.: US 2024/0365916 A1
(43) Pub. Date: Nov. 7, 2024

(54) MULTIFUNCTIONAL NBC PROTECTIVE COMBAT BOOT

(71) Applicant: CHAIRMAN, DEFENCE RESEARCH & DEVELOPMENT ORGANIZATION, New Delhi (IN)

(72) Inventors: Prabhat Garg, Gwalior (IN); Vikas Baburao Thakare, Gwalior (IN); Imran Mohammad, Gwalior (IN); Atul Kumar Sonkar, Gwalior (IN); Virendra Vikram Singh, Gwalior (IN); Pushpendra Kumar Sharma, Gwalior (IN); Arvind Kumar Gupta, Gwalior (IN)

(21) Appl. No.: 18/690,302

(22) PCT Filed: Jul. 20, 2022
(86) PCT No.: PCT/IN2022/050651

§ 371 Date: Mar. 8, 2024

(30) Foreign Application Priority Data
Sep. 8, 2021 (IN) 202111040752

(51) Int. Cl. A43B 3/02; A43B 13/12; A43B 23/02

(52) U.S. Cl. CPC A43B 3/02; A43B 13/122; A43B 13/125; A43B 23/0235

(57) ABSTRACT

A high ankle combat boot has multilayered constructions in upper and sole and has a protective function against toxic chemical agents, especially chemical warfare agents. An outer layer in the multilayered upper, away from the foot when the boot is worn, and an inner layer, faces towards the boot. An adsorption layer based on adsorbent material, especially activated carbon spheres, which absorbs toxic chemical agents, especially chemical warfare agents is arranged between the outer layer and the inner layer of the upper. An outsole in the multilayered sole, away from the foot, and an insock, faces towards the foot. An insole based on multilayered aramid cloth, which resists the puncture through the sole when stepping over sharp objects, to prevent infiltration of toxic chemical agents, especially chemical warfare agents, is arranged between the insock and outsole. Efficient protection and a high degree of comfort are achieved.

### CROSS-REFERENCE TO RELATED APPLICATIONS

This application is the U.S. National Stage of PCT/IN2022/050651 filed on Jul. 20, 2022, which claims priority to Indian Patent Application 202111040752 filed on Sep. 8, 2021, the entire content of both are incorporated herein by reference in their entirety.

### FIELD OF THE INVENTION

The present invention relates to development of protective footwear, such as a high ankle combat boot, especially multifunctional protective combat boot, against toxic chemical agents, especially chemical warfare agents, and Nuclear, Biological, and Chemical (NBC) agents, and is intended for military and security personnel's use.

### BACKGROUND OF THE INVENTION

Weapons of mass destruction mainly chemical weapons, used in First World War are still being deployed actively in acts of terrorism worldwide. A chemical warfare agent (CWA) is a chemical substance whose toxic properties are used to kill, injure or incapacitate human beings. About 70 different chemicals have been used or stockpiled as chemical warfare agents during the 20^{th} century. These agents may be in liquid, gas, solid or aerosolized state.

CWAs are classified in different categories based on their characteristics for example toxicity, persistency or volatility, chemical structures and mechanism of action. In terms of physiological effects, CWAs are classified into nerve agents, blistering agents, blood agents, choking agents, riot controlling agents, psychomimetic agents and toxins. Among all, nerve agents and blistering agents are considered with most potential due to their viable synthesis, mechanism of action, high persistency and low LD50.

Nerve agents and blistering agents are the substances that are absorbed by the skin and may harm irreversibly. Individuals who may come into contact with these toxic agents are recommended to wear protective gears made out of suitable protective materials. There are various protective gears available to protect human body, like body suits for protecting the main body, gas masks (NBC respiratory masks), often together with hoods, for protecting head, especially the face, and the respiratory tract, and NBC gloves for the protection of hands. In addition, however, it is also important that the feet are equally important for the adequate protection against these super toxic chemical agents. Rubber overboots with NBC protection are presently often used for this purpose. They are worn over regular combat boots by military and security personnel. This disadvantage involved in using NBC rubber overboots are additional weight on foot and reduced physiological comfort due to its impermeable nature. In addition, movement of individual is drastically restricted wearing NBC rubber overboots. Finally, with the use of NBC_overboot, it is not possible to achieve a required seal with an NBC protective body suit, so that toxic chemical agents, especially chemical warfare agents, can penetrate through the transition region between the NBC overboot and NBC protective body suit to act on the personnel wearing the protective gears. The alternative use of NBC protective socks with conventional combat boots, is also inefficient, as, they cannot prevent toxic agents especially chemical warfare agents from penetrating the combat boot and, further, the wearing comfort is not very high. Here again, there is the problem of inefficient seal between the NBC protective socks and the NBC protective body suit.

### SUMMARY OF THE INVENTION

Therefore, the aim of the present invention is to develop protective footwear, such as high ankle combat boot, especially multifunctional NBC combat boot which acts to protect against toxic chemical agents, especially chemical warfare agents, suitable both formilitary and security personnel's use, and avoids the aforementioned disadvantages of the NBC rubber overboot and replaces the combination of conventional combat boot and NBC rubber overboot for an individual to use in NBC scenario. The major advantage of present NBC combat boot is its multifunctionality, to use it as NBC protective boot during toxic chemicals especially chemical warfare agent scenario as well as a conventional combat boot during normal combating. There is no extra inventory of NBC rubber overboots needs to be maintained in the form of additional boot especially for NBC scenario.

To achieve the stated object, the present invention discloses footwear, such as a high ankle combat boot especially multifunctional NBC combat boot, in accordance with respective claims.

In the following, reference is made generally to an embodiment of the present invention represented by a multifunctional NBC combat boot, however this is done for better understanding of explanation and that this is a non-limiting example. Accordingly, the present invention describes a protective footwear such as high ankle combat boot especially multifunctional NBC combat boot with a multilayer construction, which has an outer layer exposed to environment when it is worn, and an inner layer, nearest to the foot when the boot is worn, and such that the multilayer construction provides a protection against toxic chemical agents, especially chemical warfare agents. This protection is provided by the incorporation of a layer, based on an adsorbent material such as activated carbon sphere (ACS) which adsorbs toxic chemicals especially chemical warfare agents. The adsorption layer is arranged or provided between the outer layer and the inner layer of the upper of the boot. The presence of the adsorption layer, which is arranged between the inner and outer layers, makes it possible to prevent toxic chemical agents, especially chemical warfare agents, which otherwise may have penetrated through all the layers of the boot, from contacting with the skin. Toxic chemicals, especially chemical warfare agents are absorbed or adsorbed by the adsorbent material of the adsorption layer, and in this way are rendered harmless. The NBC protective function of the boot, can be further enhanced by additionally incorporating a penetration resistant insole to prevent penetration of toxic chemicals especially chemical warfare agents to skin through sole by resisting puncture in case of stepping on a sharp object while combating. Other objects and features of the present invention will become apparent from the following detailed descriptions considered in conjunction with the accompanying drawings.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantages, properties, aspects and features of the present invention are apparent from the following description of a preferred embodiment of the invention, which is shown in the drawings. In the drawings:

FIG. 1 is a schematic representation of a multifunctional NBC combat boot, in accordance with a preferred embodiment of the invention;

FIG. 2 shows a schematic cross section through the layered construction of upper of multifunctional NBC combat boot, in accordance with a preferred embodiment of the invention; and

FIG. 3 shows a schematic cross section through the layered construction of sole of multifunctional NBC combat boot, in accordance with the preferred embodiment of the invention.

### DETAILED DESCRIPTION OF THE INVENTION

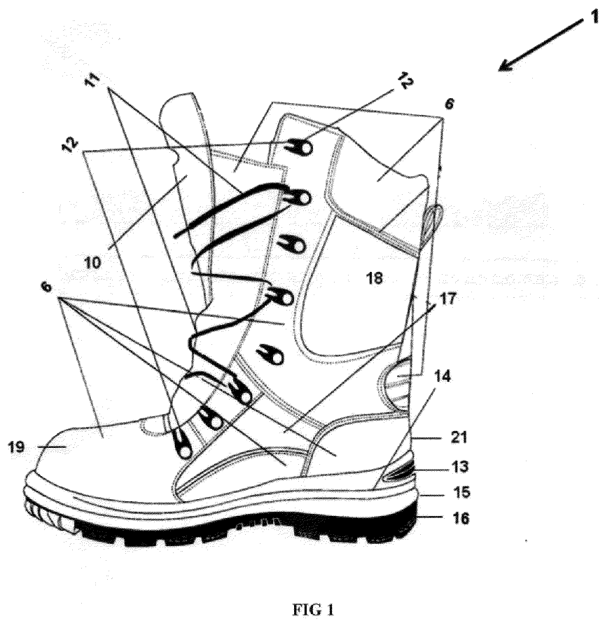

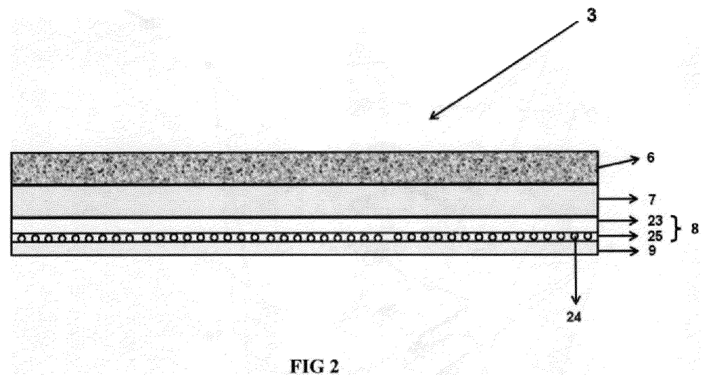

FIG. 1 shows protective footwear such as high ankle combat boot especially a multifunctional NBC combat boot (MNCB), in accordance with the invention, to get protection against toxic chemical agents, especially chemical warfare agents. The MNCB 1 of the invention has a multilayered construction 3 of the upper and multilayer construction 4 of the sole. The layered construction of upper of MNCB, shown in FIG. 2, comprises with an outer layer 6 which is farthest from the foot and an inner layer 9 which is nearest to the foot when the boot is worn. In accordance with the invention, a three layered adsorption lining 8 with an adsorbent material 24, such as activated carbon sphere (ACS), that adsorbs toxic chemical agents especially chemical warfare agents, is placed between the outer layer 6 and the inner layer 9. This provides both, efficient protection against toxic chemical agents, especially chemical warfare agents, as well as a high degree of wearing comfort.

In addition to these layers, a spacing layer, e.g., in the form of non woven fabric, a plastic, a textile, or foam may be placed between the outer layer 6 and the adsorption layer 8 or between the inner layer 9 and the adsorption layer 8. It is advantageous for the spacing layer 7 to be placed immediately next to the inner layer 9 to reduce the mechanical stress on the adsorption layer 8, because an additional layer present between the inner layer 9, and the adsorption layer 8, can absorb or dampen mechanical stresses. In case of spacing layer 7 is placed between outer layer 6 and adsorption layer 8, it helps in preventing contaminants derived from outside environment from loading the adsorbent material 24 of the adsorption layer 8. In this way, the efficiency of the adsorption layer 8 is increased. Furthermore, the additional spacing layer 7 enhances the wearing comfort of the MNCB 1 of the invention, and especially provides a cushioning effect when it is worn. In general, the individual layers 6, 7, 8 and 9 of the layered construction 3 are joined together. This is accomplished by well established methods e.g. adhesive bonding, heat sealing, sewing, stitching, etc. It is advantageous to join or the fix the individual layers 6, 7, 8 and 9 of the layered construction 3 seamlessly, preferably without damaging the individual layers 6, 7, 8 and 9 (e.g., by adhesive bonding, heat sealing, etc.). If the layers 6, 7, 8 and 9 are joined by sewing or stitching or similar method, all the layers are not stitched together e.g., seam for joining two layers is not developed with the seam of joining another two layers. Moreover, seams are sealed with seam-sealing tape on the inner side of the boot. The cohesive composite made out of individual layers 6, 7, 8 and 9 of the construction 3 is extended over the entire part of the MNCB including ankle, quarter, vamp, tongue, collar and lower including sole. In accordance with this embodiment, the individual layers 6, 7, 8 and 9 of the layered construction 3 form a cohesive boot in the shape of a foot with a leg (high ankle boot).

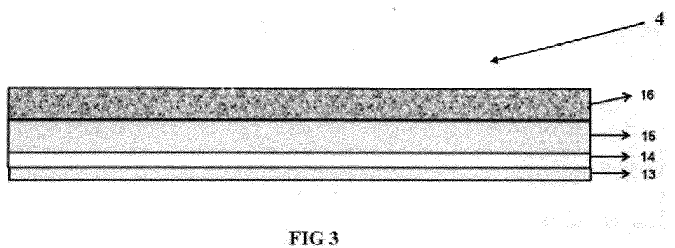

FIG. 3 shows the multilayered construction 4 of the sole of protective footwear such a high ankle combat boot especially multifunctional NBC combat boot. Outsole 16 is the farthest to the foot while insock (insert) 13 is the closest to the foot for the comfort of the wearer when the boot is worn. A puncture resistant insole 14 is provided next to insock (away from foot) to resist the puncture when the step is placed on a sharp object e.g. nail, while combating. A midsole 15 is formed next to insole (away from foot) at the time of sealing multilayer constructed upper 3 of MNCB with the multilayer constructed sole 4 along the area of contours of the foot using injection molding or any other well-known method.

In accordance with an alternative embodiment, the individual layers 6, 7, 8 and 9 of the layered construction 3 do not extend over the area of the sole, but rather only over the rest of the area of the boot, i.e., over the area of the dorsum of the foot, the ankle, and part of the calf in the case of a boot. In accordance to this embodiment, where the area of the sole of the foot is concerned, an insert with an adsorbent especially activated carbon spheres can be provided, which adsorbs toxic chemical agents especially chemical warfare agents penetrating through sole or transition area of sole. However, this is not absolutely necessary, because the multilayer construction 3 and multilayer construction 4 of the boot, when sealed together, ensure efficient protection against toxic chemical agents, especially chemical warfare agents, and at the same time a high degree of wearing comfort.

To prevent toxic chemical agents, especially chemical warfare agents, from entering through adjoining areas of the tongue, bellows tongue 10 is provided. Rust proof brass hooks 12 are provided for the lace 11 to avoiding eyelets. To retain the shape and for the purposes of safety of toes from hard objects to be hit, toe puff 19 and counter stiffener 21 made of thermoplastic polymer are provided.

The outer layer 6 of the MNCB multilayered constructed upper 3 of the invention is made of breathable, especially water vapor-permeable by using such material preferably leather of thickness approximately 2 mm. In regard to the use of breathable leather as the outer layer 6, it is advisable to the render the leather oleophobic and/or hydrophobic, especially by some treatment, to pretend or retard the penetration of toxic chemical agents especially chemical warfare agents in liquid form.

For the purposes of the present invention, under steady-state conditions and a thickness of approximately 2 mm, the outermost leather layer 6 of the NBC combat boot should have a water-vapor permeability at least 0.3 mg/cm²h, preferably at least 0.5 mg/cm²h, more preferably at least 0.8 mg/cm²h.

With respect to the material for the inner layer 9 of MNCB 1, any desired textile materials may be used, preferably air-permeable textile materials, e.g., textile cloths. Non limiting examples are woven fabrics, knitted fabrics, layered fabrics, bonded fabrics and nonwoven fabrics. Preferably, a woven or knitted antibacterial fabric with minimum tears strength if 15 N is used as the material for the inner layer 9.

With respect to the adsorption layer 8, it is generally discontinuously formed lining having three layers, i.e., the adsorption layer 8 generally comprises discrete particles of activated carbon based adsorbent 24 that adsorb toxic chemical agents especially chemical warfare agents and can be adhered on a substrate 25 using an adhesive. The adsorbent material 24 of the adsorption layer 8 is preferably a material based on activated carbon, preferably in the form of activated carbon spheres (ACS). With the use of an adsorption layer based on activated carbon spheres, the wearability characteristics of MNCB 1 of the invention are still further improved by the buffering effect of the activated carbon, because the activated carbon acts as a sweat or water store or buffer. With the use, for example, of activated carbon spheres as the adsorbent material for the adsorption layer, coverage of up to 180 g/m² or more are usual, so that, for example, in the event of seating, moisture can be stored within the pores of ACS, which, in the case of an outer layer 6 that is capable of breathing, can again be released to the outside environment. In general, the adsorption layer 8 is designed as an adsorption surface filter. For this purpose, the adsorption layer 8 contains material 24 that adsorbs toxic chemicals agents especially chemical warfare agents and is based, preferably, on activated carbon, e.g., in the form of activated carbon spheres, and the adsorbent material 24 is generally adhered on a substrate 25 using adhesive, especially a textile substrate. The adsorbent material 24 of the adsorption layer 8 is preferably applied on one side of the substrate 25 facing from the foot when the boot is worn. The adsorbent material 24 is adhered on the substrate 25 by methods that are well known to persons of skill in the art, for example, by continuous, or preferably, discontinuous application of an adhesive on the substrate, followed by adhesion of the adsorbent material 24 on the substrate 25. To increase the wearing comfort, especially to avoid stiffness of the adsorbent layer 8, discontinuous application of the adhesive, especially spotting of the adhesive is preferred, i.e., it is advantageous to apply the adsorbent material 24 to the substrate 25 discontinuously or in spots on a preferably regular pattern or grid. In this case, the actual adsorbent material 24 may be lined by a preferably air-permeable nonwoven or preferably woven textile material with weight per unit area of 80-100 g/m². In this case, the actual adsorbent material 24 may be lined by a preferably air-permeable textile material, especially a polymer cloth as a cover layer, to reduce mechanical stress of the adsorbent material (e.g., with a cloth with a low weight per unit area of 5-60 g/m² preferably 10-50-g/m², and more preferably 15-30 g/m²). To achieve an efficient adsorption capacity, it is preferred that at least 70% of the substrate 25 be covered with ACS material 24, preferably at least 80% and more preferable at least 85%. The adsorbent material 24 must not be saturated with adhesive so that adsorbent layer 8 is freely accessible to the toxic chemical agents, especially chemical warfare agents that are to be adsorbed. Suitable activated carbon spheres have a specific surface area (BET) of range being from 800 to 1,500 m²/g. The mean diameter of the particles of activated carbon spheres is less than 1.0 mm, preferably less than 0.8 mm, and more preferably less than 0.6 mm, but in general at least 0.5 mm. Activated carbon spheres, have an advantage that it has high compression strength, which is important to have good wearability. In general, the bursting pressure for an individual activated carbon particle, especially an activated carbon spherule, is preferably at least about 5 N, more preferably at least 10 N, and most preferably as high as about 15 N.

In accordance with alternative embodiment, the inner lining 9 is completely eliminated, if the substrate fabric 25 alone has sufficient stability to be self-supporting, i.e. in this case, the fabric 25 simultaneously serves as both the substrate to adsorbent material 24 and inner lining for the comfort and wearability of the user.

To prevent toxic chemical agents, especially chemical warfare agents, from penetrating the boot through the multilayered sole 4, the outsole 16 is made of a material that is substantially impermeable to toxic chemical agents, especially chemical warfare agents. In general, the outsole 16 is also substantially impermeable to any liquid, e.g. water and vapor, e.g., in air. In general, for these purposes, the outsole 16 can be made of slip resistant nitrile rubber with the preferable thickness of minimum 3 mm without the consideration of thickness of cleats that is well known to persons skilled in the art for these purposes. Said outsole 16 may further comprise antistatic filler including carbon black to discharge static charge developed during use of NBC protective boot by the wearer.

To ensure an efficient protection, the sole 16 of the boot should be joined with the upper of boot 3 to form a seal, especially in the region of the joint of the sole 4 and upper 3; this is accomplished by means of injection molding using polymer material including polyurethane based material. This polymer material forms midsole 15 upon curing. Said midsole 15 may further comprise antistatic filler including carbon black to discharge static charge developed during use of NBC protective boot by the wearer through the outsole.

With respect to the insole 14, that is provided in multilayered sole 4, it may comprised of multilayered aramid cloth with thickness approximately 2 mm and penetration resistance minimum 1100 N. Further it should have water absorption capacity of minimum 70 mg/cm² and desorption capacity of 80% of absorption capacity. Said insole is comprised of antistatic thread to discharge the static charge through insole, midsole and outsole.

With respect to the insock 13 that is provided in multilayered sole 4, it may be comprised of moulded polyurethane based laminated with polyester mesh with thickness approximately 2 mm at for part and 11 mm at heel. Further it should have water absorption capacity of minimum 70 mg/cm² and desorption capacity of 80% of adsorption capacity. Said insock is comprised of antistatic thread to discharge the static charge through insole, midsole and outsole.

In according to another embodiment, the outer layer 6 of the multilayered upper 3 may consist of a polymer coated textile fabric at quarter portion 17 and ankle portion 18 part of upper of boot. Textile fabric preferably polyurethane coated nylon fabric of the appropriate type may have for example, weight per unit area of 100-150 mg/cm² preferably 150-200 mg/cm² and more preferably 200-250 mg/cm² and water vapor permeability minimum 0.8 mg/cm²h.

The boot especially multifunctional NBC combat boot of the present invention provides efficient protection from toxic chemicals agents, especially chemical warfare agents, with the high degree of wearing comfort and functionality. A significant advantage of the combat boot in accordance with the present invention is that the boot itself is having inherent protective function against toxic chemical agents especially chemical warfare agents, and no additional equipment (e.g., NBC overboot, NBC Sock) are necessary to wear along with it. Compared to the previously described methods of NBC protection of foot, present invention not only results in considerable weight savings and increased wearing comfort, but also makes possible the achievement of an efficient sealing between the NBC combat boot and an NBC protective bodysuit, so that toxic chemical agents, especially chemical warfare agents, cannot pass through the transition region between the combat boot and protective bodysuit. Due to these properties, the boot in accordance with the present invention is suitable for NBC protection of military and security personnel. The other advantage of the present invention is the multifunctionality of the boot according to which the boot can also be worn in NBC scenario similar to conventional combat boot.

The flexibility of the individual layers of the MNCB of the invention or of composite made of layered construction as a whole results not only in a high degree of wearing comfort, but also in good fitness to the foot of wearer.

The design of the boot in accordance with the invention achieves an excellent protection against toxic chemicals especially chemical warfare agents. The protection against chemical warfare agents, especially bis(2-chloroethyl) sulfide (synonymously known as mustard gas or HD gas), as measured by Test Operations Procedure (TOP) 08-2-501A, is a maximum of 4 μg/cm² per 24 hours, still more preferably a maximum of 3.5 μg/cm² per 24 hours, preferably a maximum of 3.0 μg/cm² per 24 hours, and most preferably a maximum of 2.5 μg/cm² per 24 hours. The protection against chemical warfare agents, especially O-pinacolylmethylphosphonofluorodate (synonymously known as soman or GD), as measured by Test Operations Procedure (TOP) 08-2-501A, is a maximum of 4 μg/cm² per 24 hours, still more preferably a maximum of 3.5 μg/cm² per 24 hours, preferably a maximum of 3.0 μg/cm² per 24 hours, and most preferably a maximum of 2.5 μg/cm2 per 24 hours.

For the purpose of present invention, the total weight of the multifunctional NBC protective combat boot pair of size EU 41 should have at most 2000 gms, preferably at most 1900 gms, and more preferably 1800 gms.

The boot of the invention can be manufactured by procedures which are well known in the art. The methods are very well known to experts who are skilled in the manufacturing of footwear, without a need to provide detailed information thereon. Thus, while fundamental novel features of the invention have been shown and described and pointed out as applied to a preferred embodiment thereof, it will be understood that various omissions and substitutions and changes in the form and details of the devices illustrated, and in their operation, may be made by those skilled in the art without deviating from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. High ankle protective boot for providing protection against toxic chemicals agents especially chemical warfare agents, said protective boot comprising:
a) an outer layer, farthest from a foot of a person wearing said protective boot, said outer layer being rendered oleophobic and hydrophobic for preventing and retarding penetration of toxic chemical agents especially chemical warfare agents.
b) an inner layer, proximal to a foot of the person wearing said protective boot;
c) an adsorption layer, between said outer layer and said inner layer, and comprising an adsorption surface filter containing an adsorbent material for adsorbing toxic chemical agents especially chemical warfare agent, said adsorbent material of said adsorption layer being adhered to a textile substrate with a cover of nonwoven polymer layer and comprising activated carbon in a form activated carbon spheres; wherein said adsorbent material of said adsorption layer is applied to one side of said textile substrate facing away from the foot of the wearer when said protective boot is being worn;
d) a spacing layer configured to reduce the mechanical stress on the adsorption layer and providing comfort, wherein said spacing layer is arranged between said inner layer and said adsorption layer or arranged between outer layer and said adsorption layer and wherein said spacing layer comprises a material selected from the group consisting of a nonwoven fabric, a cellular plastic, and a textile cloth;
e) a slip resistant outer sole, distal from the foot of the person wearing said protective boot, said outer sole being impermeable to water, air, and toxic chemicals, especially chemical warfare agents;
f) a midsole, between said outer sole and insole to join upper of the said protective boot to the said outer sole;
g) an insole, between said insock and said midsole to resist the penetration of a sharp object puncturing outsole;
h) an insock next to said insole, proximal to the foot of a person wearing said protective boot;
i) rust resistance hooks for laces, designed to prevent the penetration of toxic chemicals especially chemical warfare agents which otherwise may have penetrated through the space available in case of eyelets;
j) a bellow tongue, designed to prevent the penetration of toxic chemicals especially chemical warfare agents through the transition region between tongue and upper of the said protective boot;
k) a toe puff and a counter stiffener comprises of hard plastic including thermoplastic to provide the safety of the foot of the person wearing said protective boot and to retain the shape of said protective boot;
l) The protective boot according to claim 1, wherein upper of the said protective boot is joined with outer sole using auto injection molding;

2. The protective boot according to claim 1, wherein said layer comprises a breathable and water-vapor permeable leather.

3. The protective boot according to claim 1, wherein said inner layer of upper of the said protective boot comprises a textile material including polyester.

4. The protective boot according to claim 1, wherein said adsorption layer is discontinuously formed.

5. The protective boot according to claim 1, wherein said adsorption layer comprises discrete particles of adsorbent.

6. The protective boot according to claim 1, wherein said adsorbent material of said adsorption layer comprises discrete particles of activated carbon spheres; wherein said spheres have a mean diameter from 0.5 m to 1.0 mm, wherein said activated carbon spheres are applied to said substrate in an amount of 180 g/m² or more; and wherein said activated carbon particles have a specific surface area (BET) I the range of 800 to 1,500 m²/g.

7. The combat boot according to claim 1, wherein substrate of the adsorbing materials also acts as inner liner of upper.

8. The protective boot according to claim 1, wherein outer layer at quarter and ankle portion of the upper of the said protective boot, comprises of polymer coated fabric especially polyurethane coated nylon fabric in place of leather.

9. The protective boot according to claim1, wherein said outer layer, said inner layer, said adsorption layer and spacing layer are joined to one another to alternatively form one of a layered construction and a composite.

10. The protective boot according to claim 1, wherein said outer layer, said inner layer, said adsorption layer and said spacing layer are joined using stitching, sewing or similar method, all the layers are not stitched together e.g., no two or more seams are overlapped e.g., seam joining two layers is not overlapped to seam joining other two layers.

11. The protective boot according to claim 1, wherein said slip resistant outer sole comprises of rubber including nitrile rubber.

12. The protective boot according to claim 1, wherein said outer sole comprises of antistatic filler including carbon black to discharge the static charge along a path of least resistance.

13. The protective boot according to claim 1, wherein said midsole comprises of polymer material including polyurethane and formed by sealing multilayered construction of upper of said protective boot and multilayered construction of sole of said protective boot.

14. The protective boot according to claim 1, wherein said midsole comprises of antistatic filler including carbon black in polymer matrix.

15. The protective boot according to claim 1, wherein said insole comprises of multilayered aramid cloth to provide penetration of minimum 1100 N.

16. The protective boot according to claim 1, wherein said insole comprises antistatic thread to discharge the static charge through the outer sole.

17. The protective boot according to claim 1, wherein said insock comprises of polymer material including polyurethane.

18. The protective boot according to claim 1, wherein said insock comprises of antistatic thread to discharge the static charge through the outer sole.

19. The protective boot according to claim 1, wherein said protective boot has nylon fabric on quarter and ankle portion for better air permeability and water vapor permeability.

20. The protective boot according to claim 1, wherein said protective boot comprises antistaticity at least 100 Ω.

21. The protective boot according to claim 1, wherein said protective boot has a barrier effect against toxic chemical agents to an extent of allowing passage of a maximum of 4 μg/cm² per 24 hours of toxic chemical agents especially chemical warfare agents including HD and GD.

22. The protective boot according to claim 1, wherein said the toxic chemical agents comprises at least one of chemical warfare agents and nuclear, biological and chemical (NBC) agents.

23. The protective boot according to claim 1, wherein it can be used in non NBC scenario as conventional combat boot.

24. The protective boot according to claim 1, wherein the total weight of one pair of said boot (size EU41) is at most 2000 gms, preferably 1900 gms and more preferably 1800 gms.
